(19) United States
(12) Patent Application Publication
(10) Pub. No.: US 2026/0338906 A1
(43) Pub. Date: Oct. 29, 2026

(54) UNDERWATER PASSIVE OBSERVATION SYSTEMS AND METHODS

(71) Applicant: FISHEYE ACOUSTICS LLC, Arlington, VA (US)

(72) Inventors: Marc DANTZKER, Arlington, VA (US); Ville Topias PULKKI, Espoo (FI); Vasileios BOUNTOURAKIS, Espoo (FI); Jeremy CHILDRESS, Salem, OR (US); Charles WELLER, Salem, OR (US); Kent FLETCHER, Salem, OR (US)

(73) Assignee: FISHEYE ACOUSTICS LLC, (US)

(21) Appl. No.: 19/152,958

(22) PCT Filed: Jan. 9, 2024
(86) PCT No.: PCT/US2024/010852

§ 371 Date: Aug. 1, 2025

Related U.S. Application Data
(60) Provisional application No. 63/535,902, filed on Aug. 31, 2023.

(51) Int. Cl. G01S 3/802; B63B 22/04; B63B 79/15; G01S 3/801

(52) U.S. Cl. CPC G01S 3/802; B63B 22/04; B63B 79/15; G01S 3/801

(57) ABSTRACT

An underwater passive acoustic camera UPAC apparatus includes a generally spherical outer baffle constructed of an acoustically rigid material. At least four acoustic sensors are supported in a spherical configuration on the outer surface of the outer baffle, and an inner baffle is disposed within the inner baffle between the acoustic sensors. The inner baffle has an acoustic impedance substantially lower than an acoustic impedance of water and/or substantially lower than an acoustic impedance of the outer baffle.

### CROSS REFERENCE TO RELATED APPLICATION(S)

This application claims priority to U.S. Provisional Application No. 63/535,902, filed Aug. 31, 2023, which is incorporated by reference herein in its entirety.

### TECHNICAL FIELD

The technical field relates to underwater acoustics and to the identification of fish, marine life and other underwater targets.

### BACKGROUND

Most fish (as many as 85% of species) use sound to communicate. Some fish may create sounds, for example, by rubbing their bones, armor plates or teeth together, and other fish may oscillate their swim bladder at a rapid rate to create drumming sounds. These sounds often have a low intensity and may travel only short distances, making the detection of these sounds challenging. In addition, in a setting with multiple species, it is tough to assign an individual sound to an individual fish since most don't have an apparent behavior (such as opening their mouths) associated with sound production. Overcoming these challenges, however, may allow scientists to identify different species of fish without disturbing them in their natural habitat. By identifying the sounds made by each species, it may become easier to understand how and where to protect them. To date, though, it has been estimated that only a very small proportion of species have been matched with sounds, e.g., 15% or less.

Although scientists have been observing and recording fish sounds for decades, (in fact, the first written description was Aristotle in the 4^{th} century) attributing a particular sound to a specific fish species has been difficult. Many of the fish sounds that have been identified have been observed in isolation tanks when fish may be under stress and behaving abnormally. In fact, many sounds have been elicited by stressing the animals in captivity. In crowded, natural, and undisturbed environments, it has been exceedingly difficult to establish which fish species makes which sound. Since fish may make no obvious outward movements when producing sounds, and since the various sounds of multiple fish may be simultaneously observed, misattribution of fish sounds is common.

### SUMMARY OF DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

The present disclosure generally relates to a compact underwater passive acoustic camera (UPAC), and employing data provided by the UPAC to correlate particular sonic observations with visually identifiable sources. The UPAC includes an array of at least four acoustic sensors, e.g., hydrophones, arranged in a spherical or omnidirectional configuration for full-sphere sound field recordings. The at least four acoustic sensors may be arranged such that the acoustic sensors define the vertices of a regular or irregular polyhedron, e.g. a tetrahedron, cube, dodecahedron, etc. In some embodiments, the acoustic sensors are supported on a rigid spherical (or nearly spherical) outer baffle circumscribing the polyhedron. The arrangement of the sensors in a spherical configuration does not necessarily require that the outer baffle be constructed in a spherical shape, but a sphere may be inscribed or circumscribed through the position of the acoustic sensors. Within the outer baffle, the UPAC includes a secondary inner baffle with a much lower acoustic impedance than that of the outer baffle. The outer baffle may be constructed of aluminum or another metal, and the inner baffle may be air or another gaseous medium that has a much lower acoustic impedance than water or the outer baffle. Since each of the baffles is differently reflective to sound in water, the direction of approach of a sonic observation may readily be identified using beamforming techniques based on the positions of the acoustic sensors on the outer spherical baffle.

The outer baffle may be constructed of a pair of hemispherical housing sections, or any number of partially spherical housing sections, which may be selectively locked together to form a fluid-tight housing. Wiring, power sources, and other electronics may be protected from the aquatic environment within the locked housing, but may be accessible by an operator by unlocking the housing sections.

In some embodiments, the UPAC may also include an array of 2 or more optical cameras (for capturing video or still images) interspaced within the array of acoustic sensors. Optical data acquired from the optical cameras may be overlaid with acoustic data acquired by the acoustic sensors. By accurately identifying a direction of approach of a sonic observation and mapping the direction of approach to a visual field, allows an operator to identify a likely source of the sonic observation.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a perspective view of a UPAC in accordance with aspects of the present disclosure.

FIG. 2 is a cross-sectional front view of UPAC of FIG. 1 illustrating an outer baffle constructed of two selectively separable hemispherical housing members supporting a plurality of acoustic sensors and optical cameras thereon, and an inner gaseous baffle including interior electronic components of the UPAC therein.

FIG. 3 is schematic view of an underwater passive observation system including the UPAC in an operational configuration wherein the UPAC is secured to a seabed with an anchor and communicatively coupled to a support module on the seabed.

FIG. 4 is a flowchart illustrating an example procedure for employing a UPAC to identify a source of sonic observations in accordance with aspects of the present disclosure.

FIG. 5 is an example optical map overlaid with acoustic data acquired from a UPAC in accordance with aspects of the present disclosure.

FIG. 6 is an additional optical map illustrating potential sources for sonic observations in a panoramic field of view.

FIG. 7 is an additional optical map illustrating a directional field of view in accordance with aspects of the present disclosure.

### DETAILED DESCRIPTION

The present disclosure relates generally to apparatus, systems and methods for identifying sounds associated with fish and other marine wildlife in an underwater environment. More particularly, embodiments of the present disclosure relate to identifying the specific species of marine animals that are emitting each sound produced in their natural habitats.

A more complete understanding of the components, processes and apparatuses disclosed herein can be obtained by reference to the accompanying drawings. These figures are merely schematic representations based on convenience and the ease of demonstrating the present disclosure, and are therefore not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms “generally” and “substantially” are intended to encompass structural or numeral modification which do not significantly affect the purpose of the element or number modified by such term.

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

The term “water” as used herein refers to salt water, fresh water, brackish water or other aquatic environments.

Exemplary embodiments of the present disclosure relate to devices and methods for observing and recording sounds produced by fish and other marine wildlife in their natural habitat. In particular, the disclosure relates to accurately identifying a source of distinct sonic observations.

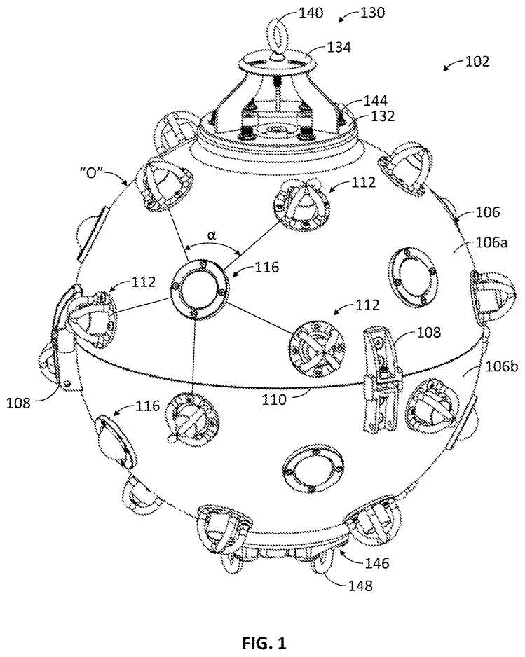

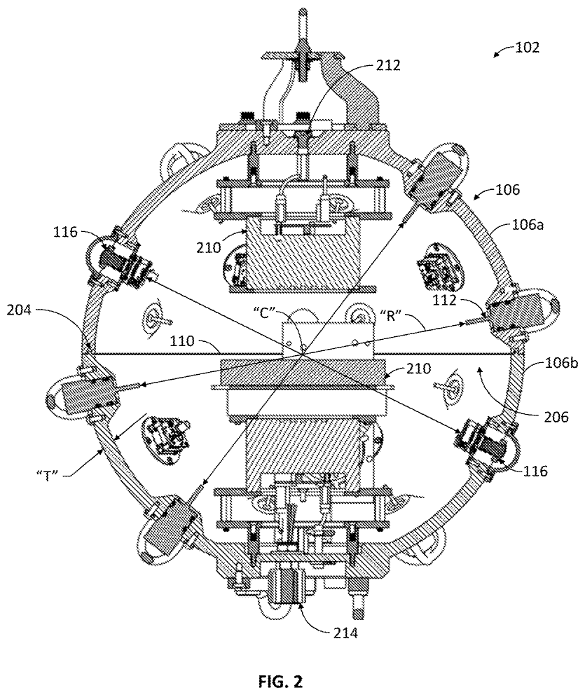

Referring now to FIG. 1 an underwater passive acoustic camera (UPAC) 102 is illustrated in accordance with example embodiments of the present disclosure. The UPAC 102 includes an outer baffle 106 generally constructed of upper and lower housing members 106a, 106b. The upper and lower housing members 106a, 106b are generally hemispherical, shells that together form generally spherical shape. In other embodiments, an outer baffle may form other geometrical shapes such as cylinders, tetrahedrons, cubes, cones, etc. without departing from the scope of the disclosure. The upper and lower housing members 106a, 106b may be constructed of aluminum, steel or other metallic material, or in some embodiments, may be constructed of a plastic, or composite material. The housing members 106a, 106b and are selectively separable from one another and are held together by connectors 108 defined across an equatorial seam 110. As illustrated, the connectors 108 include latch members, and embodiments including buckles, threads, threaded fasteners, etc. are contemplated. In other embodiments, more or fewer housing members, having regular or irregular shapes, may be joined to form the generally spherical outer baffle 102. The housing members 106a, 106b may be readily opened by disconnecting the connectors 108 to access electronics 210 (FIG. 2) and other equipment housed within the outer baffle 106.

The outer baffle 106 supports a plurality of acoustic sensors 112 and optical cameras 116 on a generally spherical outer surface “O” thereof. The acoustic sensors 112 and optical cameras 116 may be supported to protrude from the outer surface “O” or may be recessed within the outer surface “O” without departing from the scope of the disclosure. As illustrated in FIG. 1, twenty (20) acoustic sensors 112 and ten (10) optical cameras 116 are uniformly spaced about the outer baffle 106. In the other embodiments, more or fewer acoustic sensors 112 may be provided, although a minimum of four acoustic sensors should be placed in a uniform (or nearly uniform) spherical configuration for full-sphere sound field recording. Additional acoustic sensors 112 in the array that are evenly, or nearly evenly, distributed around the sphere results in improved spatial resolution (precision), higher array gain (better signal-to-noise ratio), and extended usable frequency range.

The acoustic sensors 112 may include pressure sensors, hydrophones, particle motion sensors or any appropriate sensor for detecting an underwater sound field. Using array of acoustic sensors 112 to capture the sound field may have various advantages over using a single sensor since arrays inherently contain partial information. While a single sensor 112 can be informative about the presence of a sound source in a sound field, the location of the sound's source may not be readily determined from data accumulated with the single sensor. An array of acoustic sensors 112, however can be used to extract directional information about the sound's source. Acousticians can use a beamformer (an array of spatially spaced sensors) to measure spatial parameters such as a direction-of-arrival (DoA) of the various sound sources in a sound field. For instance, the acousticians may analyze a signal received at particular individual sensors 112, and determine at which sensors, the signal experiences constructive and destructive interferences. From the signals received at the individual sensors 112, the direction from which the signal arrived may be determined. The extracted spatial information can be also used, e.g., to analytically separate simultaneous signals coming from different directions, and/or to realistically reproduce sound fields over a loudspeaker setup or headphones.

At least some techniques for identifying a direction of arrival for a sound source using a spatial array of sensors 112 includes decomposing the array information into orthonormal basis functions about the unit sphere utilizing a spherical harmonic transform (SHT). For simple geometries, such as spherical and cylindrical arrays, there are known analytical solutions to derive the spherical harmonic (SH) signals needed for further processing, while for more complex cases, including irregular shapes and non-acoustically-rigid materials, the SH signals can be derived by deploying finite-element analysis or real measurements.

Spherical arrays have distinct advantages over other geometries for applications where DoA information is to be extracted from the data collected from the acoustic sensors 112. The sphere allows for the use of analytical solutions so there is no need for cumbersome simulations and measurements. Also a sphere provides uniform resolution in all directions.

The optical cameras 116 may include any optical instrument for capturing and storing video and/or still images. The optical cameras are each oriented outwardly from a center “C” (FIG. 2) of the generally spherical outer baffle 106. In the embodiment illustrated in FIG. 1, a spherical array of ten (10) optical cameras are provided with each optical camera 116 circumscribed by a set of five (5) neighboring acoustic sensors 112. Each of the neighboring acoustic sensors 112 may be evenly circumferentially spaced from one another (at an angle a of about 72 degrees). In this way, each of the ten (10) optical cameras 116 may be arranged in a similar relative position to the twenty (20) acoustic sensors.

In one embodiment, optical cameras 116 are positioned equidistant from center C along respective radii from center C. Similarly acoustic sensors 112 are positioned equidistant from center C along respective radii from center C. In other embodiments, the optical cameras 116 may be irregularly spaced, and may be positioned between more or fewer acoustic sensors 112. The optical cameras 116 may be arranged to provide views in differing specific directions from the array of acoustic sensors 112.

The outer baffle 106 is substantially spherical, but may include deviations from an ideal sphere. For example, the acoustic sensors 112 may be protected by cages 120 protruding from the generally spherical outer surface “O.” Similarly, an upper interface plate 122 may be provided on the upper housing member 106a having lifting fixtures 124 that deviate from the outer spherical surface “O.” These deviations are likely inconsequential, particularly for longer wavelengths of sound often produced by fish. In some embodiments, the UPAC 102 may be employed to target frequencies from about 10 Hz to about 100 kHz or more. A diameter of the UPAC 102 and the array of acoustic sensors 112 may be selected to accommodate the particular frequency range targeted. Larger diameter arrays of acoustic sensors 112 may facilitate the observation of sounds with frequencies below 100 Hz and smaller arrays may facilitate the observation of higher frequencies.

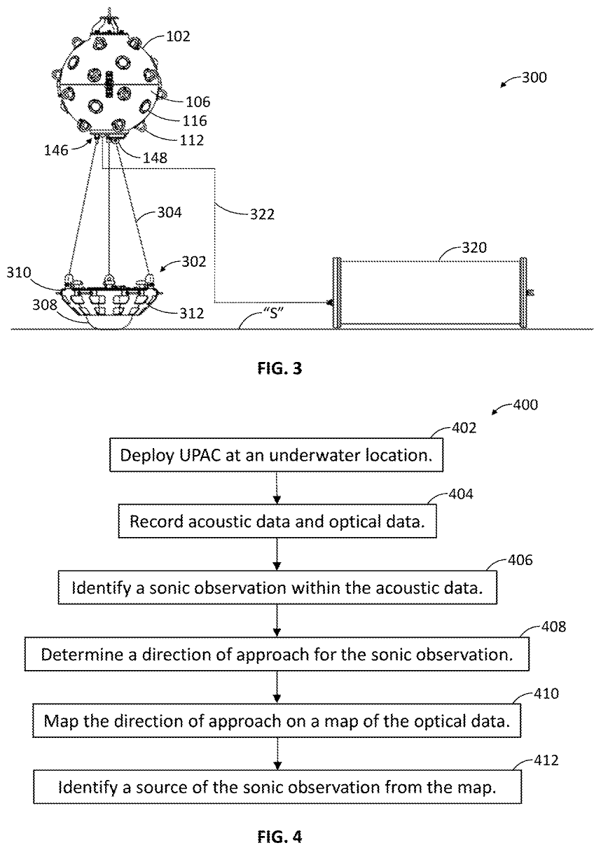

A deployment and mounting fixture 130 is provided at an upper end of the outer baffle 106. The mounting fixture 130 includes a lower plate 132 and an upper plate 134 separated by a set of vertical standoffs 138. The upper plate 134 includes a through bore that permits an eyelet fastener 140 be coupled thereto by a nut (see FIG. 2) or other hardware. The eyelet fastener 140 may be employed, e.g., to deploy or tether the UPAC 500. The lower plate 132 may be secured to the upper housing member 106a by threaded fasteners 144. A lower mounting fixture 146 is coupled to the lower housing member 106b and may include u-brackets 148 or other types of hardware to allow for flexibility in deployment or mounting of the UPAC 102. For example, the u-brackets 148 may facilitate anchoring the UPAC to a seabed as described in greater detail below with reference to FIG. 3.

Referring now to FIG. 2, the UPAC 102 is illustrated in a cross-sectional front view. The outer baffle 106 is formed with the two selectively separable hemispherical housing members 106a, 106b sealed to one another about the equatorial seam 110. The connectors 108 (FIG. 1) may maintain a compressive force on a seal member 204, e.g., an o-ring, positioned within the seam 110 such that a gaseous inner baffle 206 may be maintained within the outer baffle 106. In some embodiments, the inner baffle 206 may be formed from atmospheric air, nitrogen or another gaseous medium having a substantially lower acoustic impedance than water and/or the outer baffle 106. For example, air may have an acoustic impedance of about 0.0004 MPa at 20 °C while water may have an acoustic impedance of about 1.48 MPa (fresh water) or about 1.58 (salt water), and an aluminum outer baffle may have an acoustic impedance of 17.0 MPa. In other embodiments, the inner baffle 206 may be formed from foam or another solid material having a substantially lower acoustic impedance than the outer baffle 106. In some embodiments, the inner baffle 206 may have an acoustic impedance of about 5%, 3%, 1% or less than an acoustic impedance of the outer baffle 106.

The inner baffle 206 may thus be nearly completely reflective to sound in water. This is a significant improvement over an open system (where water may present in the spaces between the acoustic sensors 112) or a metallic-only poor impedance boundary solid where artifacts at some unresolved frequencies may be presented. The outer baffle 106 may be constructed as an acoustically rigid member. As an acoustically rigid member, the outer baffle will have a reflection coefficient close to 1 such that sound bounces back with no phase shift. For example, the outer baffle 106 may be constructed of a metallic material such as steel or aluminum with a relatively high modulus of elasticity to suppress vibrations in the outer baffle. A thickness “T” of the outer baffle 106 may be sufficiently high to suppress any vibrations being transferred from the surrounding water to the outer baffle 106. For example, the thickness “T” may be ⅜ of an inch or larger in some embodiments. By supporting the acoustic sensors 112 on a rigid boundary, such as outer baffle 106, disposed about an inner baffle 206, rather than providing an open array or a practically open array wherein the sensors are supported by a lattice or frame, artifacts generated by sound passing between the acoustic sensors may be reduced or eliminated. In addition, the outer baffle 106 offers additional directivity in lower frequencies. The rigid construction of the outer baffle 106 may permit the acoustic sensors 112 to protrude from the outer surface of the outer baffle 106, while still allowing for a direction of arrival of a sound source to be readily determined.

As illustrated in FIG. 2, each of the acoustic sensors 112 and the optical cameras 116 are oriented along a radius “R” extending from a center “C” of the spherical outer baffle 106. The common orientation of each of the acoustic sensors 112 and optical cameras 116 may facilitate processing of the various signals observed by the acoustic sensors 112 and optical cameras 116.

A vent 212 or a one-way pressure relief valve is provided at an upper end of the outer baffle 106 to allow gasses to pass out from the outer baffle in operation, e.g., if the gasses forming the inner baffle 206 are heated by electronics 210. The electronics 210 may include a visual processor, a network interface, an audio interface, controller, processor, memory, and other components for operating the UPAC 102. The inner baffle 206 provides a dry housing for the operation of the electronics 210 that support the acoustic sensors 112 and the optical cameras 116. Air-tight cable couplers 214 may protrude from an underside of the outer baffle 106 (or from any location on the outer baffle 106) such that the electronics 210 may be communicatively coupled to exterior memory, power, processors or other external systems (see FIG. 3) while the UPAC 102 is in use. In other embodiments, the electronics 210 may be accessed by removing the UPAC 102 from the water and separating the upper and lower hemispherical housings 106a, 106b from one another.

Referring to FIG. 3, an underwater passive observation system 300 includes the UPAC 102 in an operational configuration wherein the UPAC 102 is secured to a seabed “S” or another subaquatic surface. The UPAC 102 is coupled to an anchor 302 by tethers 304, which may extend between the anchor 302 and the u-brackets 148 of the lower mounting fixture 146. The tethers 304 may be constructed of cables, chains, guy lines or other flexible members that permit the UPAC 102 to float above the seabed “S.” The UPAC 102 is elevated above the sea bed “S” and may collect sonic and optical observations from every direction, including from below the UPAC 102. A length of the tethers 304 may be varied to position the UPAC 102 at an appropriate height for observing a desired field of view.

The anchor 302 may include weight 308 that counteracts the buoyancy of the UPAC 102 when the UPAC 102 is deployed at an underwater location. The anchor 302 may also include a basket 310 including openings 312 therein, which may correspond with locations of the acoustic sensors 112 and optical cameras 116 on the UPAC 102. The UPAC 102 may thus rest within the basket 310 for handling in a laboratory or prior to deployment to the underwater location, without damaging the acoustic sensors 112 and optical cameras 116.

The UPAC 102 may be communicatively coupled to a support module 320 on the seabed “S.” The support module 320 may include memory, power, processors or other external systems therein, which may be coupled to the electronics 210 (FIG. 2) within the UPAC 102. The support module 320 may be coupled to the UPAC with cables 322 extending from the cable couplers 214 protruding from the outer baffle 106.

Referring to FIG. 4, a procedure 400 is illustrated for employing an underwater passive acoustic camera (UPAC) to identify a source of sonic observations such as fish sounds in accordance with aspects of the present disclosure. Initially at step 402, the UPAC is deployed at an underwater location. The underwater location may be, e.g., a reef environment, where many different species of fish congregate. The UPAC may be positioned on a mounting base, suspended from a floating platform, tethered and stabilized by guy lines extending to the sea bed, or otherwise positioned in an underwater position of interest. At step 404, the UPAC is employed to passively record acoustic and optical data from each of a plurality of acoustic sensors and optical cameras carried by the UPAC. The observations and recordings may be designated as “passive” since the acoustic and optical data are collected directly from the natural environment, rather than observations and recordings of, e.g., reflections of signals broadcast to interact with the surrounding environment. The acoustic and optical data gathered in step 404 may be gathered from a 360° field of view around the UPAC.

At step 406, a sonic observation may be identified from within the acoustic data. For example, a suspected fish sound may be compared to previously recorded samples or a predetermined range of parameters. If a sonic observation of interest is identified, the procedure 400 proceeds to step 408 where a direction of approach of the sonic observation is determined. As described above, the differences between the acoustic data collected from the various acoustic sensors may be analyzed to determine a direction from which the sonic observation of interest likely originated.

Next, at step 410, the direction of approach may be mapped onto a visual map of the optical data collected at the time of the sonic observation. The map may be created by stitching together images captured by the plurality of optical cameras carried by the UPAC. At step 412, a source of the sonic observation may be identified from the map. For example, where a fish or other wildlife is visible on the map in a direction of the direction of arrival, the fish or other wildlife may be identified as a likely source of the sonic observation.

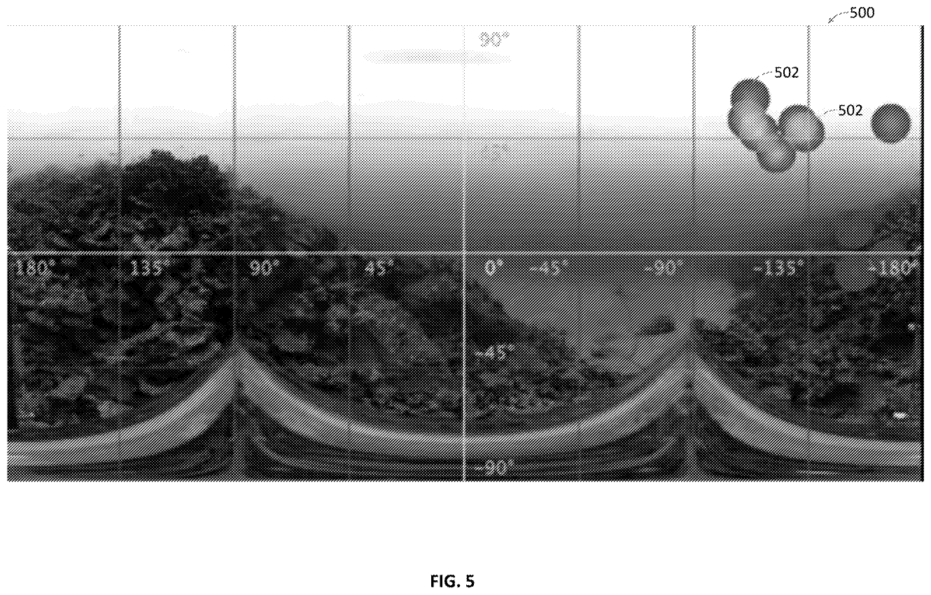

Referring to FIG. 5, an example optical map 500 overlaid with acoustic data acquired from a UPAC in accordance with aspects of the present disclosure. The optical map 500 extends 360° around a subaquatic location where the UPAC may have been deployed. Markers 502 are illustrated in the direction of arrival for several sonic observations. The markers 502 may obscure a fish, such as a triggerfish, visible on the map 502. The triggerfish may thus be identified as the source of the sonic observation.

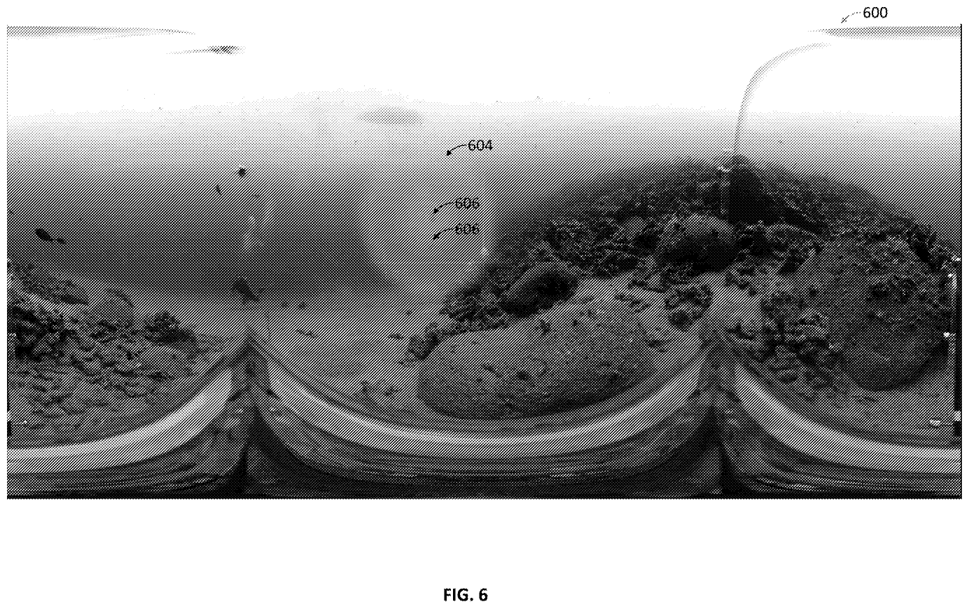

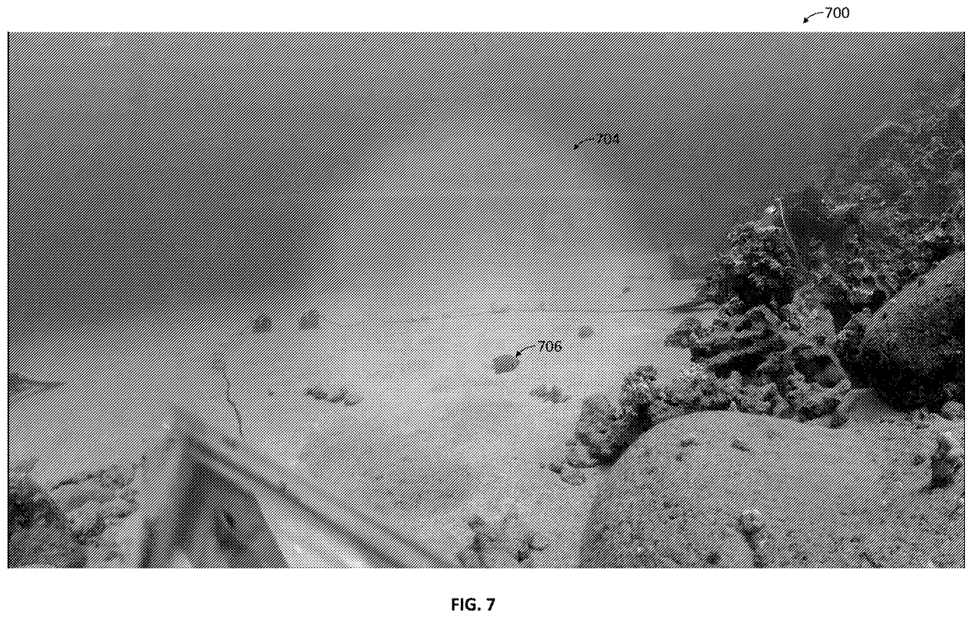

Referring to FIG. 6, another example of an optical map 600 is overlaid with acoustic data acquired from a UPAC in accordance with aspects of the present disclosure. The optical map 600 displays a panoramic view extending 360° around the UPAC. The panoramic view may have been stitched together from several different optical cameras carried by the UPAC. A marker 604 is illustrated in the direction of arrival for a particular sonic observation. The marker 604 may be formed from a plurality of rings of differing color or pattern centered about the direction of arrival. The marker 604 may be generally transparent such that the marker 604 does not obscure fish 606 or other potential sources of the sonic observation.

Referring to FIG. 7, another example of an optical map 700 is overlaid with acoustic data acquired from a UPAC in accordance with aspects of the present disclosure. The optical map 700 displays a directional view, illustrating the subaquatic environment in a single direction form the UPAC. The directional view may be formed from optical data collected from a single optical camera. A marker 704 is illustrated in the direction of arrival for a particular sonic observation, and may identify a fish 706 as a potential source of a sonic observation.

Other embodiments of the disclosure include a method for identifying an underwater sound source, the method comprising: deploying an underwater passive acoustic camera (UPAC) at an underwater location, the UPAC including an outer baffle that surrounds an inner baffle having an acoustic impedance substantially lower than an acoustic impedance of the outer baffle; observing acoustic data from a plurality of acoustic sensors supported in a on an outer surface of the outer baffle; identifying a sonic observation within the acoustic data; determining a direction of approach for the sonic observation from the acoustic data from the plurality of acoustic sensors; and locating potential sources of the sonic observation disposed in the direction of approach.

In some embodiments, the method may further comprise recording optical data with the UPAC and mapping the direction of approach on a visual map of the optical data. In some embodiments observing the acoustic data from a plurality of acoustic sensors includes observing acoustic data from at least 4 acoustic sensors of the plurality of sensors arranged in a spherical pattern, and in some embodiments recording the optical data comprises recording the optical data with an optical camera circumscribed by at least three of the acoustic sensors evenly spaced around the optical camera. In one or more embodiments locating potential sources of the sonic observation includes locating an image of a fish on the visual map corresponding with the direction of approach mapped onto the visual map. In some embodiments, the method further comprises separating a plurality of housing members forming the outer baffle to access electronics housed within the outer baffle.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. An underwater passive acoustic camera (UPAC) apparatus, comprising:
an outer baffle constructed of an acoustically rigid material and defining an outer surface;
a plurality of acoustic sensors supported on the outer surface of the outer baffle and arranged to observe a sound field defined around the outer baffle;
a plurality of optical cameras spaced around the outer baffle and circumscribed by at least a portion of the plurality of acoustic sensors, the plurality of optical cameras operable to provide a visualization of the sound field observed by the plurality of acoustic sensors; and
an inner baffle disposed within the outer baffle between the acoustic sensors, the inner baffle having an acoustic impedance substantially lower than an acoustic impedance of water and/or substantially lower than an acoustic impedance of the outer baffle.

2. The apparatus of claim 1, wherein the acoustically rigid material of the outer baffle is a metallic material and wherein the inner baffle is a gaseous baffle sealed within the outer baffle.

3. The apparatus of claim 2, wherein the outer baffle is constructed of a plurality of housing members having a seal member disposed in a seam defined between the housing members, and wherein the housing members are selectively coupled to one another with at least one connector extending across the seam.

4. The apparatus of claim 3, wherein the plurality of housing members comprises a pair of hemispherical housing members.

5. The apparatus of claim 1, wherein the plurality of acoustic sensors includes at least four acoustic sensors arranged in a spherical pattern.

6. The apparatus of claim 5, wherein the sound field is a 360 degree sound field around the outer baffle.

7. The apparatus of claim 6, wherein each of the plurality of the at least four acoustic sensors is equally spaced around the respective optical camera.

8. The apparatus of claim 1, wherein the outer surface of the outer baffle is generally spherical, and wherein each of the plurality of optical cameras is oriented along a respective radius of the generally spherical outer surface and concentric with each of the acoustic sensors.

9. A method for underwater passive observation, the method comprising:
deploying the apparatus of claim 1; and
sensing acoustic data with the plurality of acoustic sensors.

10. An underwater passive observation system, comprising
an outer baffle constructed of an acoustically rigid material and defining an outer surface and a center therein;
a plurality of acoustic sensors supported on the outer surface of the outer baffle wherein each acoustic sensor is equidistant from the center;
a plurality of optical cameras spaced around the outer baffle equidistant from the center and oriented outwardly from the center, wherein each of the optical cameras is circumscribed by at least two acoustic sensors circumferentially spaced about a respective optical camera.
an inner baffle disposed within the outer baffle between the acoustic sensors, the inner baffle having an acoustic impedance substantially lower than an acoustic impedance of water and/or substantially lower than an acoustic impedance of the outer baffle; and
an anchor coupled to the outer baffle for securing the outer baffle at an underwater location.

11. The system of claim 10, further comprising a support module coupled to the outer baffle with one or more cables.

12. The system of claim 10, wherein the plurality of acoustic sensors includes at least twenty acoustic sensors arranged in a spherical pattern.

13. The system of claim 12, wherein the plurality of optical cameras includes at least ten optical cameras spaced around the outer baffle, wherein each of the optical cameras is circumscribed by at least five of the at least twenty acoustic sensors evenly spaced about a respective optical camera.

14. The system of claim 13, further comprising electronics operable to determine a direction of approach for a sonic observation from acoustic data observed by the at least twenty acoustic sensors and optical data observed by the at least ten optical cameras.

15. The system of claim 13, wherein the anchor includes a basket having openings defined therein corresponding to a location of the acoustic sensors and optical cameras on the outer baffle.

16. The apparatus of claim 1, wherein each of the plurality of acoustic sensors is positioned equidistant from a center defined within the outer baffle.

17. The apparatus of claim 16, wherein each of the plurality of optical cameras is oriented outwardly from the center along a respective radius extending from the center within the outer baffle such that the optical cameras observe a visual field from the same perspective and from the same location from which the plurality of acoustic sensors are arranged to observe the sound field.

18. The apparatus of claim 17, wherein the outer surface of the outer baffle is generally spherical and concentric with each of the acoustic sensors and each of the optical cameras.

19. The method of claim 9, further comprising:
collecting optical data with the plurality of optical cameras;
overlaying the acoustic data on the optical data; and
determining a direction of approach for a sonic observation within the acoustic data from the acoustic data and the optical data.

20. The system of claim 10, further comprising electronics operable to determine a direction of approach for a sonic observation from acoustic data observed by the plurality of acoustic sensors and optical data observed by the plurality of optical cameras.
